(19) United States
(12) Patent Application Publication
(10) Pub. No.: US 2021/0271988 A1
(43) Pub. Date: Sep. 2, 2021

(54) REINFORCEMENT LEARNING WITH ITERATIVE REASONING FOR MERGING IN DENSE TRAFFIC

(71) Applicants: Honda Motor Co., Ltd., Tokyo (JP); The Board of Trustees of the Leland Stanford Junior University, Stanford, CA (US)

(72) Inventors: Maxime Bouton, Mountain View, CA (US); David Francis Isele, Sunnyvale, CA (US); Alireza Nakhaei Sarvedani, San Jose, CA (US); Mykel Kochenderfer, Palo Alto, CA (US); Kikuo Fujimura, Palo Alto, CA (US)

(21) Appl. No.: 16/940,680

(22) Filed: Jul. 28, 2020

Related U.S. Application Data
(60) Provisional application No. 62/983,370, filed on Feb. 28, 2020.

(51) Int. Cl. G06N 5/04; G06N 20/00; G05D 1/02

(52) U.S. Cl. CPC G06N 5/04; G05D 1/0088; G05D 1/0221; G06N 20/00

(57) ABSTRACT

According to one aspect, a system for reinforcement learning with iterative reasoning may include a memory for storing computer readable code and a processor operatively coupled to the memory, the processor configured to receive a level-0 policy and a desired reasoning level n. The processor may repeat for k=1 . . . n times, the following: populate a training environment with a level-(k−1) first agent, populate the training environment with a level-(k−1) second agent, and train a level-k agent based on the level-(k−1) first agent and the level-(k−1) second agent to derive a level-k policy.

### CROSS-REFERENCE TO RELATED APPLICATIONS

This application claims the benefit of U.S. Provisional Patent Application, Ser. No. 62/983,370 (Attorney Docket No. H1201160US01) entitled REINFORCEMENT LEARNING WITH ITERATIVE REASONING FOR MERGING IN DENSE TRAFFIC, filed on Feb. 28, 2020; the entirety of the above-noted application(s) is incorporated by reference herein.

### BACKGROUND

In recent years, major progress has been made to deploy autonomous vehicles. However, certain common driving situations like merging in dense traffic may still be challenging for autonomous vehicles. Without good models for interactions with human drivers, standard planning algorithms are often too conservative.

Maneuvering in dense traffic is a challenging task for autonomous vehicles because it requires reasoning about the stochastic behaviors of many other participants. In addition, the agent must achieve the maneuver within a limited time and distance.

### BRIEF DESCRIPTION

According to one aspect, a method for reinforcement learning with iterative reasoning may include providing a level-0 policy and a desired reasoning level n, populating a training environment with a level-0 first agent, populating the training environment with a level-0 second agent, training a level-1 agent based on the level-0 first agent and the level-0 second agent and deriving a level-1 policy, populating the training environment with a level-1 first agent associated with a first behavior, populating the training environment with a level-2 second agent associated with a second behavior, and training a level-2 agent based on the level-1 first agent and the level-2 second agent and deriving a level-2 policy.

The first behavior may be a lane-keep behavior. The second behavior may be a lane-change behavior. A state associated with the level-0 first agent, level-0 second agent, level-1 agent, level-1 first agent, level-2 second agent, or the level-2 agent may include a longitudinal position, a lateral position, a longitudinal velocity, and a lateral velocity. The level-0 first agent, level-0 second agent, level-1 agent, level-1 first agent, level-2 second agent, or the level-2 agent may follow an intelligent driver model (IDM) for longitudinal maneuvers. The level-0 first agent and the level-0 second agent may follow the level-0 policy. The level-0 policy may be a predetermined rule-based policy. The method may include training the level-2 agent based on the level-0 first agent and the level-0 second agent. The level-0 policy may include a longitudinal driver model and a lane change model. Training the level-1 agent and the level-2 agent may be based on a reward function.

According to one aspect, a system for reinforcement learning with iterative reasoning may include a memory for storing computer readable code and a processor operatively coupled to the memory, the processor configured to receive a level-0 policy and a desired reasoning level n, populate a training environment with a level-0 first agent, populate the training environment with a level-0 second agent, train a level-1 agent based on the level-0 first agent and the level-0 second agent to derive a level-1 policy, populate the training environment with a level-1 first agent associated with a first behavior, populate the training environment with a level-2 second agent associated with a second behavior, and train a level-2 agent based on the level-1 first agent and the level-2 second agent to derive a level-2 policy.

The first behavior may be a lane-keep behavior. The second behavior may be a lane-change behavior. A state associated with the level-0 first agent, level-0 second agent, level-1 agent, level-1 first agent, level-2 second agent, or the level-2 agent may include a longitudinal position, a lateral position, a longitudinal velocity, and a lateral velocity. The level-0 first agent, level-0 second agent, level-1 agent, level-1 first agent, level-2 second agent, or the level-2 agent may follow an intelligent driver model (IDM) for longitudinal maneuvers. The level-0 first agent and the level-0 second agent may follow the level-0 policy. The level-0 policy may be a predetermined rule-based policy. The method may include training the level-2 agent based on the level-0 first agent and the level-0 second agent. The level-0 policy may include a longitudinal driver model and a lane change model.

According to one aspect, a system for reinforcement learning with iterative reasoning may include a memory for storing computer readable code and a processor operatively coupled to the memory, the processor configured to receive a level-0 policy and a desired reasoning level n. The processor may repeat for k=1 . . . n times, the following: populate a training environment with a level-(k−1) first agent, populate the training environment with a level-(k−1) second agent, and train a level-k agent based on the level-(k−1) first agent and the level-(k−1) second agent to derive a level-k policy.

### BRIEF DESCRIPTION OF THE DRAWINGS

FIG. 1 is an exemplary component diagram of a network architecture associated with a system for reinforcement learning with iterative reasoning, according to one aspect.

FIG. 2 is an exemplary traffic scenario where a network architecture associated with a system for reinforcement learning with iterative reasoning may be implemented, according to one aspect.

FIG. 3 is an exemplary agent associated with a system for reinforcement learning with iterative reasoning may be implemented, according to one aspect.

FIG. 4 is an exemplary component diagram of a system for reinforcement learning with iterative reasoning, according to one aspect.

FIG. 5 is an exemplary flow diagram of a method for reinforcement learning with iterative reasoning, according to one aspect.

FIG. 6 is an illustration of an example computer-readable medium or computer-readable device including processor-executable instructions configured to embody one or more of the provisions set forth herein, according to one aspect.

FIG. 7 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, driving, and/or safety. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

According to aspects of the present disclosure, systems and methods for reinforcement learning with iterative reasoning for merging in dense traffic are provided. The system may provide a combination of reinforcement learning and game theory to learn merging behaviors. A training curriculum for a reinforcement learning agent using the concept of level-k behavior is provided. This approach may expose the agent to a broad variety of behaviors during training, which promotes learning policies that are robust to model discrepancies.

The present disclosure provides for reinforcement learning with iterative reasoning for merging in dense traffic. Maneuvering in dense traffic is a challenging task for autonomous vehicles because it requires reasoning about the stochastic behaviors of many other participants. In addition, the agent should achieve the maneuver within a limited time and distance.

A combination of reinforcement learning and game theory to learn merging behaviors may be provided. A training curriculum for a reinforcement learning agent using the concept of level-k behavior may be generated. This approach may expose the agent to a broad variety of behaviors during training, which may promote learning policies that are robust to model discrepancies.

The learned model may help to obtain good policies but the search algorithm is limited by the online computation. To avoid the computational constraint of online methods, one may address the problem using reinforcement learning. In reinforcement learning, the agent interacts with a simulation environment many times prior to execution, and at each simulation episode, improves its strategy. The resulting policy may then be deployed online and may be cheap to evaluate. Reinforcement learning provides a flexible framework to automatically find good decision strategies. Recent advances using neural network representations of policies have allowed reinforcement learning to scale to very complex environments. Such approaches have been successfully applied to autonomous driving applications in lane change scenarios and intersection navigation. However, the scenarios considered often have sparse traffic conditions and consider a small number of other agents. Additionally, reinforcement learning agents are known to learn policies that over-fit to the training environment.

Reinforcement learning may be used to navigate dense traffic scenarios (e.g., a gap of around two (2) meters between vehicles). The maneuver may be a success when the agent passes the stopped vehicles (e.g., caused by a broken down car). In such a situation, many decisions for the agent may be used to change lanes and pass the stopped vehicles. At any time, a wrong decision may lead to a deadlock or an unsafe situation. These two challenges are commonly referred to as sparse and delayed reward problems.

To address this issue, a curriculum learning approach based on a cognitive hierarchical model to learn efficient policies in challenging environments is provided. This approach utilizes a level-k modeling to generate a variety of behavior in the training environment. Each cognitive level may be trained in a reinforcement learning environment populated with vehicles of any lower cognitive level. Standard reinforcement learning techniques may fail to learn a good strategy. In contrast, this approach may change the behavior of other agents in the environment and enables the learning of robust policies.

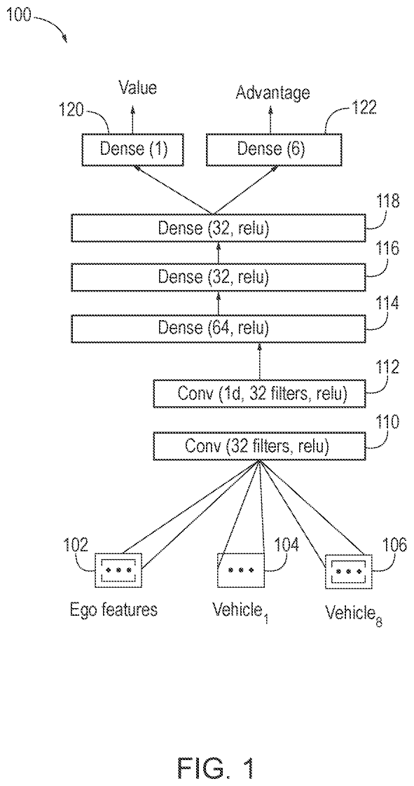

FIG. 1 is an exemplary component diagram of a network architecture 100 associated with a system for reinforcement learning with iterative reasoning, according to one aspect. The network architecture may include one or more convolutional layers which enable sharing of weights when processing other vehicle states.

The input to the network architecture 100 is divided into two sets of features: the ego features 102, and the other vehicle features 104, 106 (i.e., positions and speeds). The other vehicle features 104, 106 may be processed using a convolutional network including convolutional layers 110, 112, 114, 116, 118, 120, 122 which ensures translation independence between the features. The network architecture may learn a similar representation for position, and velocity independently of the associated vehicle. The other vehicle features may be combined with the ego vehicle features using a fully connected layer. The policy network maps the input features to two streams, a value stream from layer 120 representing the value of the current observation, and an advantage stream from layer 122 representing the advantage of each action. The agent may select the action with an optimal or best advantage. Splitting the end of the policy network between advantage and value is known as dueling and may improve deep Q-learning.

To mitigate the computational constraint, the problem may be addressed using reinforcement learning. In other words, reinforcement learning may be applied to navigate dense traffic scenarios. For example, a dense traffic scenario may be a scenario where vehicles are less than two meters apart. In reinforcement learning, the agent may interact with a simulation environment (many times) prior to execution, and at each simulation episode, improve its strategy. The resulting policy may be deployed and may be cheap to evaluate. Reinforcement learning may provide a flexible framework to automatically determine efficient decision strategies.

Recent advances using neural network representations of policies have enabled reinforcement learning to scale to very complex environments. Such approaches have been successfully applied to autonomous driving applications in lane change scenarios and intersection navigation. However, the scenarios considered often have sparse traffic conditions and consider a small number of other agents. Additionally, reinforcement learning agents may learn policies that over-fit to the training environment.

At any time, a decision may lead to a deadlock or an undesirable scenario. These challenges may be referred to as sparse and delayed reward problems. To address this issue, a curriculum learning approach based on a cognitive hierarchical model to learn efficient policies in challenging environments may be implemented via the architecture of FIG. 1. Level-k modeling may be implemented to generate a variety of behavior in the training environment. Each cognitive level may be trained in a reinforcement learning environment populated with vehicles of any lower cognitive level. Typical reinforcement learning techniques would fail to learn a proper response strategy. By contrast, the iterative procedure provided by the architecture of FIG. 1 to change the behavior of other agents in the environment enables the learning of robust policies.

According to one aspect, Markov decision processes and reinforcement learning may be implemented to address the decision making problem, along with level-k behavior modeling, which inspired the design of the curriculum learning strategy.

Reinforcement Learning

Sequential decision making processes may be modeled as Markov Decision Processes (MDPs). MDPs may be defined by the tuple (S, A, T, R, γ) where S is a state space, A is an action space, T is a transition model, R is a reward function, and γ is a discount factor. An agent may choose an action a E A in a given state s and receives a reward r=R(s, a). The environment may then transition into a state s′ according to the distribution Pr(s′|s, a)=T (s, a, s′).

The agent's action may be given by a policy π: S→A mapping states to actions. The agent's goal may be to find the policy that maximizes its value, given by the accumulated expected discounted reward given by Σₜ₌₀^{∞}γ^{t}rₜ. Each policy may be associated to a state-action value function Q^{π}: S×A→ [symbol] representing the value of following the policy π. The optimal state action value function of an MDP satisfies the Bellman equation:

$${Q}^{*} ( s , a ) = {𝔼}_{{s}^{′}} [ R ( s , a ) + {γ}_{\frac{ma x}{{a}^{′}}} {Q}^{*} ( {s}^{′} , {a}^{′} ) ] \qquad ( 1 )$$

The associated optimal policy may be given by

$${π}^{*} ( s ) = arg {max}_{a} {Q}^{*} ( s , a ) .$$

In an MDP with large or continuous state spaces, the state action value function may be represented by a parametric model such as a neural network: Q(s, a; θ).

Reinforcement learning may be a procedure to find the optimal state action value function of an MDP. The agent may interact with the environment and gather experience samples. Each sample may be in the form of a tuple (s, a, s′, r). Given an experience sample, the weights of the network may be updated to approximate the Bellman equation as follows:

$$θ ← θ + α ( r + {γ}_{\frac{ma x}{{a}^{′}}} Q ( {s}^{′} , {a}^{′} ; {θ}_{-} ) - Q ( s , a ; θ ) ) {∇}_{θ} Q ( s , a ; θ ) \qquad ( 2 )$$

where α is the learning rate, and θ₋ represents the weight of a target network. This may be referred to as deep Q-learning, and may be augmented with prioritized replay, dueling, and double Q-learning.

Cognitive Hierarchy Modeling

According to one aspect, the training curriculum may be based on the level-k cognitive hierarchy model from behavioral game theory. This model may include assumptions that an agent performs a limited number of iterations of strategic reasoning (e.g., “I think that you think that I think”). A level-k agent may act optimally against the strategy of a level-(k−1) agent. Level-0 may correspond to a random policy or a heuristic strategy. Given a level-k strategy, a system for reinforcement learning may formulate the problem of finding the level-(k+1) policy as the search for an optimal policy in an MDP where the other entities in the environment follow a level-k policy.

According to one aspect, a training curriculum may be implemented to compute an iterative response up to a given level of strategic reasoning. For example, given a strategic level n, solve n reinforcement learning problems iteratively to compute a strategy of level n by populating the training environment with agents of lower strategic levels. As n goes to infinity, the solution of such iterative procedure may converge to a Nash equilibrium. However, a limited number of iterations may be implemented to manage computing resources. Behavioral game theory has shown that a reasoning level of 2 or 3 is a better approximation to human behavior than Nash equilibrium. Therefore, limiting the reasoning level of an autonomous agent to 4, for example, may enable anticipation of human behaviors.

Agent Design—Action Space

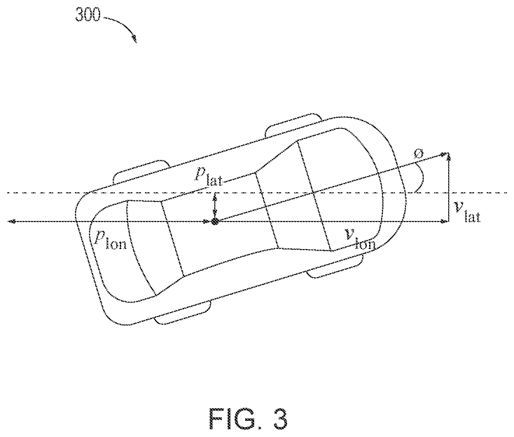

The state of an agent may be described by four quantities: longitudinal and lateral positions and longitudinal and lateral velocities, as illustrated in FIG. 3. The state of other entities may be described relative to the ego vehicle state. The agent may control its longitudinal and lateral motions. The longitudinal motion may be controlled using an intelligent driver model (IDM). The agent may select among desired velocity levels, such as 0 m/s, 3 m/s, 5 m/s, etc. This decision may be converted into a longitudinal acceleration using an equation from the IDM model. By using the IDM model to compute the acceleration, the behavior of braking (e.g., if there is a vehicle in front) need not be learned. In this way, the longitudinal action space is accounted for by design. This may be thought of as a form of shield to the reinforcement learning agent from taking undesirable actions. Other drivers or vehicles may have stochastic behaviors and may cause collisions.

The lateral motion of the ego vehicle or agent may be determined to be one of two actions: stay in a current lane or change lanes. A lateral acceleration may then computed using a proportional derivative controller:

aₗₐₜ=−kₚpₗₐₜ−k_{d}vₗₐₜ (3)

where pₗₐₜ may be the lateral position of the vehicle with respect to the center line of the lane and vₗₐₜ may be the lateral velocity of the vehicle, in a direction normal to the center line, kₚ and k_{d} may be controller gains. According to one aspect, given the dense nature of the traffic, no threshold rules associated with lateral movement is applied because large gaps may be rare in this type of scenario.

A total number of actions may be the combination of the three longitudinal actions and two lateral actions, thereby resulting in 6 joint actions.

The lateral and longitudinal acceleration commands are used to update the physical state of the agent according to the following dynamics:

p′ₗₒₙ=pₗₒₙ+vₗₒₙδt (4)

p′ₗₐₜ=pₗₐₜ+vₗₐₜδt (5)

v′ₗₒₙ=vₗₒₙ+aₗₒₙδt (6)

v′ₗₐₜ=vₗₐₜ+aₗₐₜδt (7)

where δt may be a simulation step (e.g., 0.1 s), and the primed quantities correspond to the updated value of the state. This dynamics model may be fast to simulate. To account for model inaccuracies, constraints may be added to the steering rate and the maximum steering angle of 0.4 rad/s and 0.5 rad, respectively, to limit the lateral motion of the vehicle.

The agent may take an action every predetermined amount (e.g., 5) of simulation steps (e.g., 0.5 s between two actions). The learned policy may be high level. At deployment, the agent may decide on a desired speed and a lane change command, while a lower level controller, operating at faster frequency, may execute the motion and triggering emergency braking system, if needed.

Agent Design—Input Features

Each vehicle in the environment may be represented by its longitudinal and lateral position, longitudinal and lateral velocity, a heading angle, and a longitudinal and lateral acceleration. According to one aspect, it may be assumed that the agent may observe its own state perfectly. In addition, the agent may observe vehicles in the neighboring lanes within a predetermined range, such as 30 m, for example. In this regard, for each vehicle present in this field of view, the ego vehicle may measure:

relative longitudinal and lateral position; and

relative longitudinal and lateral velocity

As the number of vehicles within the field of view of the agent may vary, a cap may be placed on this number, such as to the 8 closest vehicles, to provide a fixed size input to the reinforcement learning agent. If there are less than 8 agents in the vicinity of the ego vehicle, a fixed feature vector associated to absent vehicles may be sent.

However, the agent does not have full observability of the environment because it may neither observe the acceleration of other agent nor the internal states governing their behavior. Measurement uncertainty may be handled online (e.g., after training) using the QMDP approximation technique.

Curriculum with Iterative Reasoning (Level-k)

According to one aspect, the network architecture of FIG. 1 may provide a design associated with an efficient training procedure to mitigate issues with reinforcement learning, including sparse rewards, delayed rewards, and generalization. Level-k modeling may be utilized to design an efficient training curriculum.

Generally, the model of the agent, as well as the behavior of traffic participants in the simulation environment should match the real world as closely as possible. In addition, the environment should be sufficiently diverse such that the agent may generalize to a variety of scenarios. The training curriculum for the system of reinforcement learning may enable learning a variety of behaviors, and diversifies the population of drivers in the environment as the cognitive level (level-k) increases. An agent with a high level of reasoning may then have been exposed to a variety of behaviors, and as a result, its policy may generalize better.

The curriculum learning of the system may be based on the level-k behavior model. Initially, an agent may be trained to perform a lane change in a crowded traffic scenario where all other agents follow a level-0 policy. The level-0 policy may be a hand-engineered rule-based policy, as defined below in the level-0′ section. This trained agent may be referred to as level-1. Thereafter, the curriculum may train an agent to follow the top lane safely, while agents on the bottom lane follow either a level-0 or level-1 policy. This agent may be referred to as a level-2 agent. The curriculum learning may including training a level-3 agent by populating the top lane with level-0 and/or level-2 agents and the bottom lane with level-0 and/or level-1 agents. This procedure may be repeated until a sufficiently high level of reasoning is reached. According to one aspect, agents associated with an odd reasoning level may be performing lane change maneuvers (e.g., merging agents) while agents associated with an even reasoning level may be performing a keep lane maneuver. The level-0 agents may perform both maneuvers and may be spread between the two lanes. Unlike traditional level-k modeling, where a level-k agent optimizes against a level-(k−1) agent, the level-k agent optimizes against the population of level-0 through level-(k−1) agents. In other words, optimization may include level-0, level-1, level 2, . . . level-(k−1) agents.

Level-0

Parameters associated with the curriculum may include a maximum reasoning level, the level-0 policy, and a distribution over the reasoning level. The maximum reasoning level may be a level to which an agent may be trained. At each step of the curriculum, the performance of the new level may be evaluated and a decision as to whether to continue the training or not may be made. For example, policies may be trained up to level 5. To accelerate training at each time step, weights from the previous iteration may be utilized to start training. Since the even agents and odd agents are associated with learning different tasks (i.e., merge or keep lane), the weight with the previous level may be initialized corresponding to the same task.

The level-0 policy may include of a combination of a longitudinal driver model, and a lane change model. The longitudinal model may have a constant desired speed drawn from a distribution, and the lateral model may select to change lane or not based on a set of hand-engineered rules. Similarly as for the agent design, these decisions may be converted into a longitudinal acceleration aₗₒₙ and a lateral acceleration aₗₐₜ.

The longitudinal model may be an extension of the IDM model with a cooperation parameter and a perception parameter. A parameter η_{percept} may determine a yield area. If a vehicle is in this yield area, a yield action may be sampled according to a Bernoulli distribution of parameter c. If c=1, the driver may yield. This longitudinal driver model enables computation of a longitudinal acceleration aₗₒₙ.

The lateral motion may be governed by a lane tracker and a lane change model. MOBIL may be implemented to determine when to perform the lane change. Given a desired lane, the lateral acceleration aₗₐₜ may be determined by the PD controller described in Equation (3). The state of the vehicle may be updated using the dynamics model described herein.

To ensure a diverse training environment, different level-0 agents may be sampled by changing parameters of the longitudinal model. Adding noise in the driver model parameters may facilitate the higher level agents generalize, as they will be exposed to a variety of behavior during training.

Reward Function

Contrary to standard level-k reasoning, the even levels and odd levels of the level-k reasoning implemented herein correspond to different tasks (i.e., keep lane or change lane). For both tasks, the reward function may have the same additive structure. The reward function may include the following terms:

Penalty for collisions: (−1)

Penalty for deviating from a desired velocity: −0.001|v_{ego}−v_{desired}|

Reward for being in the top lane: (+0.01 for the merging agent and 0 for the keep lane agent)

Reward for passing the blocked vehicle: (+1)

In this way, the weight of each component may be designed to keep the accumulated reward within a reasonable numerical range to promote convergence of the Q-network.

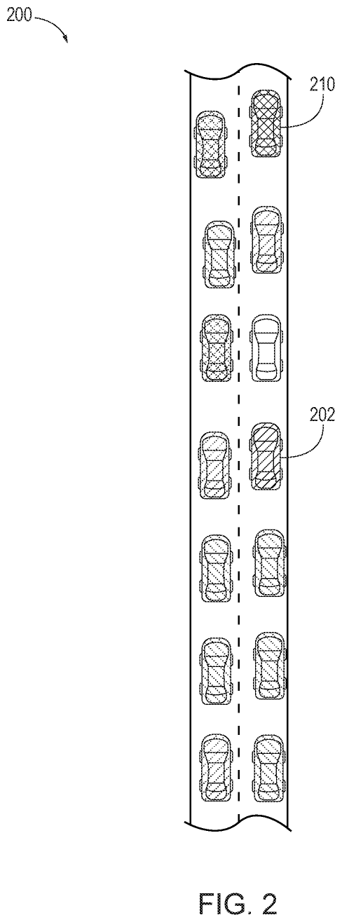

FIG. 2 is an exemplary traffic scenario 200 where a network architecture associated with a system for reinforcement learning with iterative reasoning may be implemented, according to one aspect. In recent years, major progress has been made to deploy autonomous vehicles and improve safety. However, certain driving scenarios, such as merging in dense traffic may still be challenging for autonomous vehicles. Scenarios like the one illustrated in FIG. 2 often involve negotiating with human drivers. Without good models for interactions with human drivers, standard planning algorithms are often too conservative. An autonomous vehicle 202 may navigate dense traffic, which may include a stopped vehicle 210. The stopped vehicle 210 may cause the ego vehicle to change lanes in a very short distance, in order to move forward or progress. In this scenario 200, other vehicles on the road may have different behaviors from collaborative to aggressive, for example. A maneuver may be defined as a successful maneuver when the agent or autonomous vehicle 202 passes the stopped vehicle 210. Additionally, multiple maneuvers and/or decisions may be executed for the agent to change lanes and pass the stopped vehicle 210.

FIG. 3 is an exemplary agent 300 associated with a system for reinforcement learning with iterative reasoning may be implemented, according to one aspect. A longitudinal and a lateral position are shown with respect to a center line of an associated lane (e.g., the dashed line). The longitudinal and lateral velocities may be a function of an orientation of the vehicle with respect to the center line.

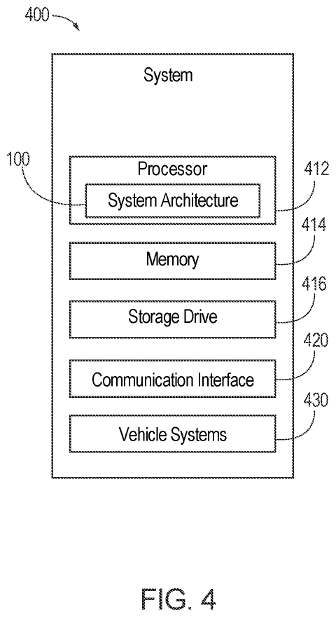

FIG. 4 is an exemplary component diagram of a system 400 for reinforcement learning with iterative reasoning, according to one aspect. The system 400 for reinforcement learning with iterative reasoning may include a processor 412, a memory 414, a storage drive 416, a communication interface 420, and one or more vehicle systems 430, which may include a vehicle controller or a proportional derivative controller. The storage drive 416 may store one or more policies learned during the curriculum training described above. One or more of the vehicle systems 430 may implement actions (e.g., lane changes, braking, accelerating, steering, etc.) based on implementation of the policies described herein. According to one aspect, the system architecture 100 may be implemented via the processor 412.

According to one aspect, a system 400 for reinforcement learning with iterative reasoning may include a memory 414 for storing computer readable code and a processor 412 operatively coupled to the memory 414, the processor 412 configured to receive a level-0 policy and a desired reasoning level n. The processor 412 may repeat for k=1 . . . n times, the following: populate a training environment with a level-(k−1) first agent, populate the training environment with a level-(k−1) second agent, and train a level-k agent based on the level-(k−1) first agent and the level-(k−1) second agent to derive a level-k policy.

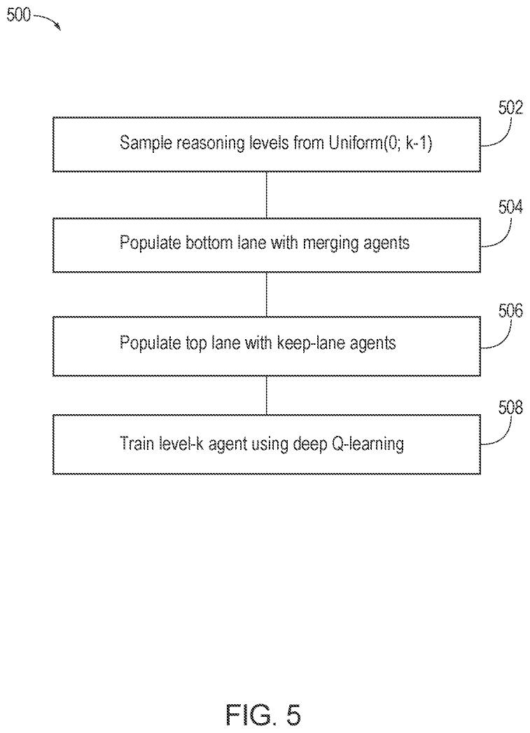

FIG. 5 is an exemplary flow diagram of a method 500 for reinforcement learning with iterative reasoning, according to one aspect. In FIG. 5, an input may be a level-0 policy and a maximum or desired reasoning level N. The method 500 may be repeated for k=1 . . . N times. At 502, reasoning levels may be sampled from Uniform (0,k−1). At 504, a first lane (e.g., bottom lane) may be populated with merging agents. At 506, a second lane (e.g., top lane) may be populated with keep-lane agents. At 508, an agent may be trained to level-k using deep Q-learning according to the environment associated with the merging agents and the keep-lane agents of 504, 506.

According to one aspect, a method for reinforcement learning with iterative reasoning may include providing a level-0 policy and a desired reasoning level n, populating a training environment with a level-0 first agent, populating the training environment with a level-0 second agent, training a level-1 agent based on the level-0 first agent and the level-0 second agent and deriving a level-1 policy, populating the training environment with a level-1 first agent associated with a first behavior, populating the training environment with a level-2 second agent associated with a second behavior, and training a level-2 agent based on the level-1 first agent and the level-2 second agent and deriving a level-2 policy.

The first behavior may be a lane-keep behavior. The second behavior may be a lane-change behavior. A state associated with the level-0 first agent, level-0 second agent, level-1 agent, level-1 first agent, level-2 second agent, or the level-2 agent may include a longitudinal position, a lateral position, a longitudinal velocity, and a lateral velocity. The level-0 first agent, level-0 second agent, level-1 agent, level-1 first agent, level-2 second agent, or the level-2 agent may follow an intelligent driver model (IDM) for longitudinal maneuvers. The level-0 first agent and the level-0 second agent may follow the level-0 policy. The level-0 policy may be a predetermined rule-based policy. The method may include training the level-2 agent based on the level-0 first agent and the level-0 second agent. The level-0 policy may include a longitudinal driver model and a lane change model. Training the level-1 agent and the level-2 agent may be based on a reward function.

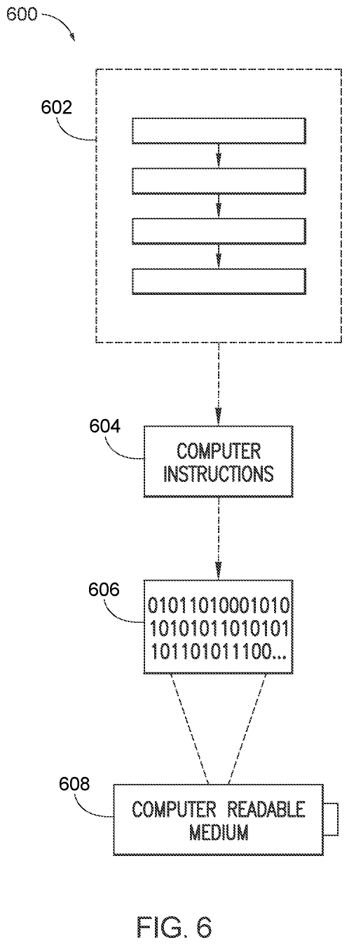

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the method 500 of FIG. 5. In another aspect, the processor-executable computer instructions 604 may be configured to implement a system, such as the system 400 of FIG. 4. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

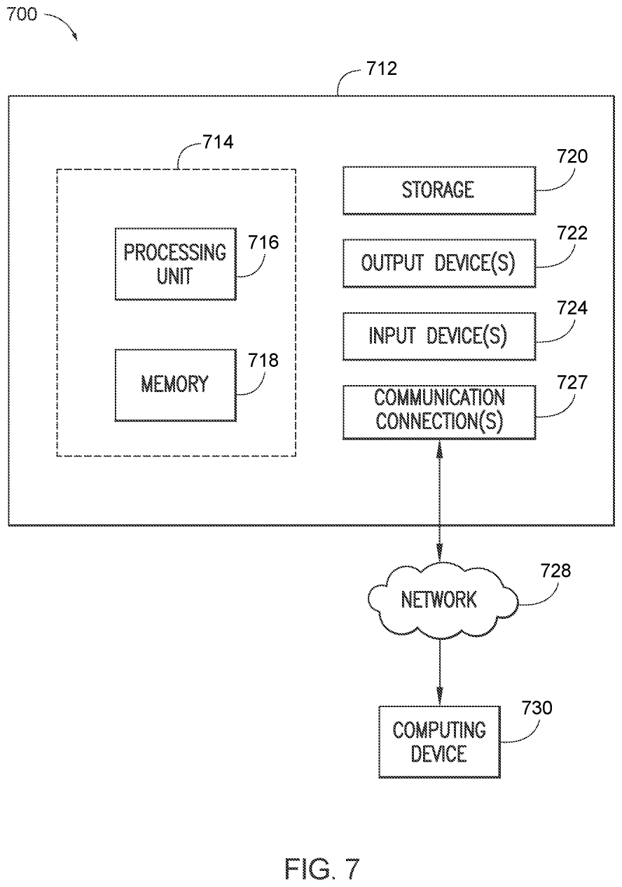

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including a computing device 712 configured to implement one aspect provided herein. In one configuration, the computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for reinforcement learning with iterative reasoning, comprising:
providing a level-0 policy and a desired reasoning level n;
populating a training environment with a level-0 first agent;
populating the training environment with a level-0 second agent;
training a level-1 agent based on the level-0 first agent and the level-0 second agent and deriving a level-1 policy;
populating the training environment with a level-1 first agent associated with a first behavior;
populating the training environment with a level-2 second agent associated with a second behavior; and
training a level-2 agent based on the level-1 first agent and the level-2 second agent and deriving a level-2 policy.

2. The method for reinforcement learning with iterative reasoning of claim 1, wherein the first behavior is a lane-keep behavior.

3. The method for reinforcement learning with iterative reasoning of claim 1, wherein the second behavior is a lane-change behavior.

4. The method for reinforcement learning with iterative reasoning of claim 1, wherein a state associated with the level-0 first agent, level-0 second agent, level-1 agent, level-1 first agent, level-2 second agent, or the level-2 agent includes a longitudinal position, a lateral position, a longitudinal velocity, and a lateral velocity.

5. The method for reinforcement learning with iterative reasoning of claim 1, wherein the level-0 first agent, level-0 second agent, level-1 agent, level-1 first agent, level-2 second agent, or the level-2 agent follow an intelligent driver model (IDM) for longitudinal maneuvers.

6. The method for reinforcement learning with iterative reasoning of claim 1, wherein the level-0 first agent and the level-0 second agent follow the level-0 policy.

7. The method for reinforcement learning with iterative reasoning of claim 6, wherein the level-0 policy is a predetermined rule-based policy.

8. The method for reinforcement learning with iterative reasoning of claim 1, comprising training the level-2 agent based on the level-0 first agent and the level-0 second agent.

9. The method for reinforcement learning with iterative reasoning of claim 1, wherein the level-0 policy includes a longitudinal driver model and a lane change model.

10. The method for reinforcement learning with iterative reasoning of claim 1, wherein training the level-1 agent and the level-2 agent is based on a reward function.

11. A system for reinforcement learning with iterative reasoning, comprising:
a memory for storing computer readable code; and
a processor operatively coupled to the memory, the processor configured to:
receive a level-0 policy and a desired reasoning level n;
populate a training environment with a level-0 first agent;
populate the training environment with a level-0 second agent;
train a level-1 agent based on the level-0 first agent and the level-0 second agent to derive a level-1 policy;
populate the training environment with a level-1 first agent associated with a first behavior;
populate the training environment with a level-2 second agent associated with a second behavior; and
train a level-2 agent based on the level-1 first agent and the level-2 second agent to derive a level-2 policy.

12. The system for reinforcement learning with iterative reasoning of claim 11, wherein the first behavior is a lane-keep behavior.

13. The system for reinforcement learning with iterative reasoning of claim 11, wherein the second behavior is a lane-change behavior.

14. The system for reinforcement learning with iterative reasoning of claim 11, wherein a state associated with the level-0 first agent, level-0 second agent, level-1 agent, level-1 first agent, level-2 second agent, or the level-2 agent includes a longitudinal position, a lateral position, a longitudinal velocity, and a lateral velocity.

15. The system for reinforcement learning with iterative reasoning of claim 11, wherein the level-0 first agent, level-0 second agent, level-1 agent, level-1 first agent, level-2 second agent, or the level-2 agent follow an intelligent driver model (IDM) for longitudinal maneuvers.

16. The system for reinforcement learning with iterative reasoning of claim 11, wherein the level-0 first agent and the level-0 second agent follow the level-0 policy.

17. The system for reinforcement learning with iterative reasoning of claim 16, wherein the level-0 policy is a predetermined rule-based policy.

18. The system for reinforcement learning with iterative reasoning of claim 11, wherein the processor trains the level-2 agent based on the level-0 first agent and the level-0 second agent.

19. The system for reinforcement learning with iterative reasoning of claim 11, wherein the level-0 policy includes a longitudinal driver model and a lane change model.

20. A system for reinforcement learning with iterative reasoning, comprising:
a memory for storing computer readable code; and
a processor operatively coupled to the memory, the processor configured to:
receive a level-0 policy and a desired reasoning level n;
repeat for k=1 . . . n times, the following:
populate a training environment with a level-(k−1) first agent;
populate the training environment with a level-(k−1) second agent; and
train a level-k agent based on the level-(k−1) first agent and the level-(k−1) second agent to derive a level-k policy.
